(19) United States
(12) Patent Application Publication
(10) Pub. No.: US 2008/0018495 A1
(43) Pub. Date: Jan. 24, 2008

(54) System and Method For Distributing Advertising Information

(76) Inventors: Katherine A. Dunning, Austin, TX (US); Michael A. Paolini, Austin, TX (US); Cristi N. Ullmann, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/459,405

(22) Filed: Jul. 24, 2006

(51) Int. Cl. G08G 1/123

(52) U.S. Cl. 340/988

(57) ABSTRACT

A method, system, and computer-usable medium for distributing advertising information. According to a preferred embodiment of the present invention, an advertising server determining a type of vehicle, responsive to determining the type of vehicle, receiving information for display, and displaying the information. The information for display may be sent based on a variety of factors, including, but not limited to the type of vehicle, location of vehicle, proximity to other vehicles, weather of the current location, date, and/or time.

### BACKGROUND OF THE INVENTION

1. Technical Field

The present invention relates in general to the field of data processing systems. More particularly, the present invention relates to the field of networked data processing systems. Still more particular, the present invention relates to a system and method for distributing advertising information.

2. Description of the Related Art

In today's world, many people spend a non-trivial amount of time commuting for work and/or leisure. The effectiveness of traditional roadside advertisements (e.g., billboards, etc.) depends greatly on the location of the advertisement. However, traffic patterns vary by the time of day or day of week (e.g., rush hour vs. late Sunday night). There is a need for a system and method for more efficiently providing advertisement information to consumers.

### SUMMARY OF THE INVENTION

The present invention includes a method, system, and computer-usable medium for distributing advertising information. According to a preferred embodiment of the present invention, an advertising server determining a type of vehicle, responsive to determining the type of vehicle, receiving information for display, and displaying the information. The information for display may be sent based on a variety of factors, including, but not limited to the type of vehicle, location of vehicle, proximity to other vehicles, weather of the current location, date, and/or time.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary network in which a preferred embodiment of the present invention may be implemented;

FIG. 2-3 are block diagrams depicting an exemplary data processing systems in which a preferred embodiment of the present invention may be implemented; and

FIG. 4 is a high-level logical flowchart illustrating an exemplary method for distributing advertising information according to a preferred embodiment of the present invention.

### DETAILED DESCRIPTION OF A PREFERRED EMBODIMENT

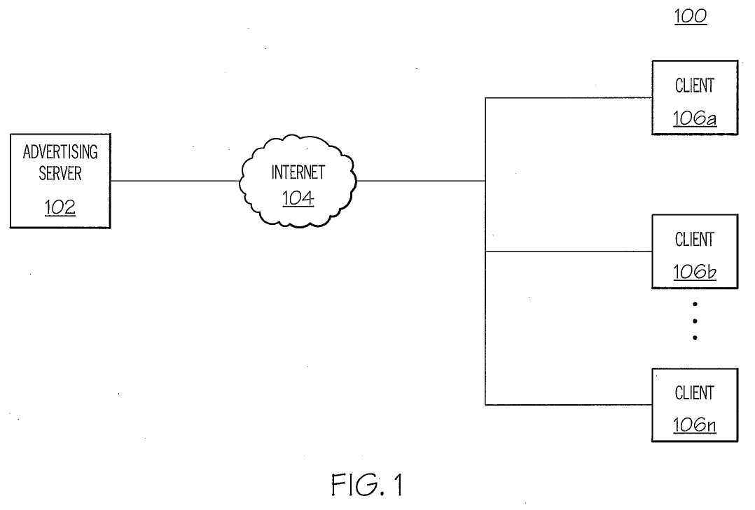

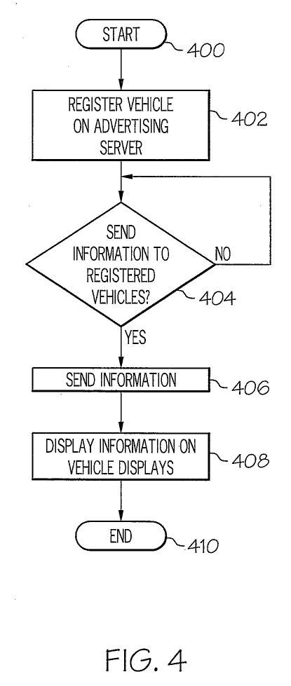

Referring now to the figures, and in particular, referring to FIG. 1, there is illustrated a block diagram depicting an exemplary network 100 in which a preferred embodiment of the present invention may be implemented. As illustrated, network 100 includes advertising server 102, Internet 104, and clients 106a-n. Clients 106a-n are preferably coupled to Internet 104, or any other signal-bearing medium, via a wireless connection including, but not limited to satellite, wide-area network, or other connections. In a preferred embodiment of the present invention, advertising server 102 disseminates advertising information to clients 106a-n depending on a variety of factors discussed herein in more detail in conjunction with FIG. 3. In a preferred embodiment of the present invention, clients 106a-n may be implemented as computer systems installed in vehicles, as described herein in more detail in conjunction with FIGS. 3 and 4.

It should be understood by those skilled in the art that exemplary network 100 can include many additional components not specifically illustrated in FIG. 1. Because such additional components are not necessary for an understanding of the present invention, they are not illustrated in FIG. 1 or discussed further herein.

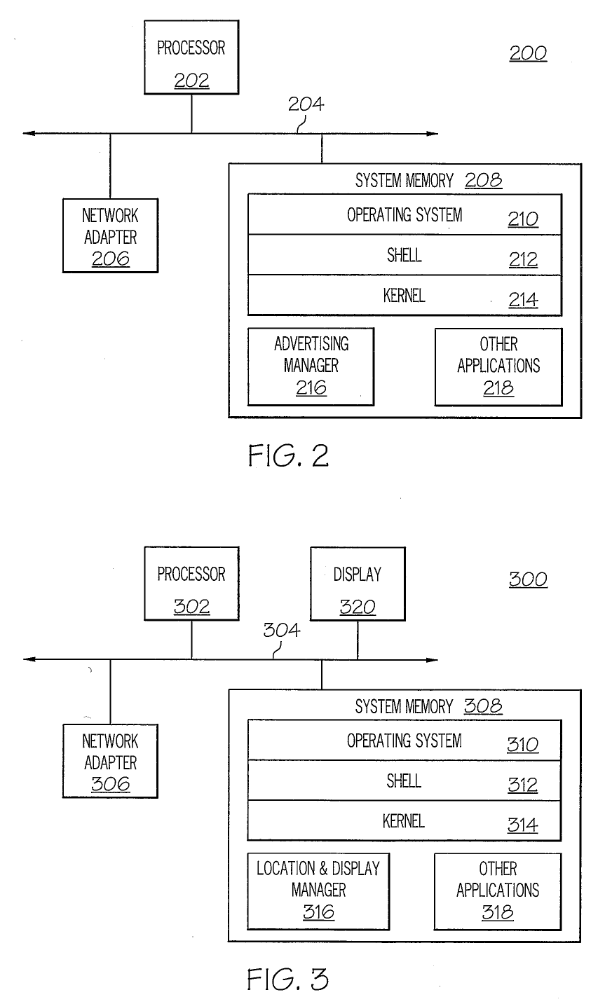

FIG. 2 is a block diagram illustrating an exemplary data processing system 200 which may be utilized to implement advertising server 102 as depicted in FIG. 1. As depicted, processor 202 is coupled to network adapter 206 and system memory 208 via system interconnect 204. Network adapter 206 couples data processing system 200 to a network, such as Internet 104.

Preferably, system memory 208 may be implemented as a collection of dynamic random access memory (DRAM) modules. As illustrated, system memory 208 includes operating system 210, which further includes shell 212 for providing transparent user access to resources such as application programs 218. Generally, shell 212 is a program that provides an interpreter and an interface between the user and the operating system. More specifically, shell 212 executes commands that are entered into a command line user interface or a file. Thus, shell 212 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 214) for processing. Note that while shell 212 is a text-based, line-oriented user interface, the present invention will support other user interface modes, such as graphical, voice, gestural, etc. equally well.

As illustrated, operating system 210 also includes kernel 214, which includes lower levels of functionality for operating system 210, including providing essential services required by other parts of operating system 210 and application programs 218, including memory management, process and task management, disk management, and mouse and keyboard management. Application programs 218 may include word processors, spreadsheets, and other application programs. Advertising manager 216 sends out advertising information to clients 106a-n based on factors discussed in more detail herein in conjunction with FIG. 4.

It should be understood by those skilled in the art that exemplary data processing system 200 can include many additional components not specifically illustrated in FIG. 2A. Because such additional components are not necessary for an understanding of the present invention, they are not illustrated in FIG. 2A or discussed further herein.

FIG. 3 is a block diagram depicting an exemplary data processing system 300 in which may be included in clients 106a-n as illustrated in FIG. 1. As depicted, processor 202 is coupled to network adapter 206 and system memory 208 via system interconnect 304. Network adapter 306 couples data processing system 300 to a network, such as Internet 104.

Preferably, system memory 308 may be implemented as a collection of dynamic random access memory (DRAM) modules. As illustrated, system memory 308 includes operating system 310, which further includes shell 312 for providing transparent user access to resources such as application programs 318. Generally, shell 312 is a program that provides an interpreter and an interface between the user and the operating system. More specifically, shell 312 executes commands that are entered into a command line user interface or a file. Thus, shell 312 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 314) for processing. Note that while shell 312 is a text-based, line-oriented user interface, the present invention will support other user interface modes, such as graphical, voice, gestural, etc. equally well.

As illustrated, operating system 310 also includes kernel 314, which includes lower levels of functionality for operating system 310, including providing essential services required by other parts of operating system 310 and application programs 318, including memory management, process and task management, disk management, and mouse and keyboard management. Application programs 318 may include word processors, spreadsheets, and other application programs. Location and display manager 316 receives advertising information from advertising server 102 clients 106a-n based on factors such as input from light and rain sensors, other external sensor data such as weather reports, traffic reports, construction reports, time of day and season, etc. as discussed in more detail herein in conjunction with FIG. 4. Location and display manager 316 controls the display of advertising information on display 320.

It should be understood by those skilled in the art that exemplary data processing system 300 can include many additional components not specifically illustrated in FIG. 3. Because such additional components are not necessary for an understanding of the present invention, they are not illustrated in FIG. 3 or discussed further herein.

FIG. 4 is a high-level logical flowchart illustrating an exemplary method for distributing advertising information according to a preferred embodiment of the present invention. The process begins at step 400 and proceeds to step 402, which illustrates a user registering a client (e.g., vehicle equipped with a computer and display system similar to data processing system 300 depicted in FIG. 3) on advertising server 102. The process continues to step 404, which illustrates advertising server 102 determining whether to send advertising information to registered clients 106a-n. Advertising server 102 queries clients 106a-n for a variety of information including, but not limited to: the make and model of the vehicles, whether or not the vehicles are parked, the location of where the vehicles are parked (e.g., public or private parking, etc.), the data/time or the location (e.g., GPS coordinates) of the vehicles, the orientation of the vehicles with respect to the parking area, the proximity of the vehicles to predetermined locations (e.g., proximity to certain businesses, etc.), the proximity of the vehicles to other vehicles that may display advertising information to form a collective display, etc. In a preferred embodiment of the present invention, clients 106a-n include a global positioning system (GPS) module within location and display manager 316 to determine the location of registered clients. If advertising server 102 determines, based on the aforementioned factors, that advertising will not be sent to clients 106a-n, the process iterates at step 404.

If advertising server 102 determines, based on the aforementioned factors, that advertising will be sent to clients 106a-n, the process continues to step 406, which depicts advertising server 102 sending advertising information to clients 106a-n based on the received location information. The process resumes at step 408, which illustrates location and display manager 316 displaying the received advertising information on display 320. In another preferred embodiment of the present invention, received advertising information may also include audio tracks that may be played over speakers installed in the vehicles represented by clients 102a-n. The process ends, as illustrated at step 410.

As discussed, the present invention includes a method, system, and computer-usable medium for distributing advertising information. According to a preferred embodiment of the present invention, an advertising server determining a type of vehicle, responsive to determining the type of vehicle, receiving information for display, and displaying the information. The information for display may be sent based on a variety of factors, including, but not limited to the type of vehicle, location of vehicle, proximity to other vehicles, weather of the current location, date, and/or time.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks, including Ethernet, the Internet, wireless networks, and like network systems. It should be understood, therefore, that such signal-bearing media when carrying or encoding computer readable instructions that direct method functions in the present invention represent alternative embodiments of the present invention. Further, it is understood that the present invention may be implemented by as a system having means in the form of hardware, software, or a combination of software and hardware as described herein or their equivalent.

What is claimed is:

1. A method of displaying information utilizing a display mounted on a vehicle, said method comprising:
determining a type of vehicle;
responsive to determining said type of vehicle, receiving information for display; and
displaying said information.

2. The method according to claim 1, further comprising:
receiving said information for display responsive to determining a location where said vehicle is parked.

3. The method according to claim 1, further comprising:
receiving said information for display responsive to determining a date and/or time at a location where said vehicle is parked.

4. The method according to claim 1, further comprising:
receiving said information for display responsive to determining a distance between a predetermined location and a location where said vehicle is parked.

5. The method according to claim 1, further comprising:
receiving said information for display responsive to other vehicles located near said at least one vehicle, wherein said received information forms part of a collective display.

6. The method according to claim 1, further comprising:
receiving said information for display responsive to other vehicles located near said at least one vehicle, wherein said received information provides additional details to an existing display on said other vehicles.

7. A system comprising:
a processor;
a data bus coupled to said processor;
a computer-usable medium embodying computer program code, said computer-usable medium being coupled to said data bus, said computer program code comprising instructions executable by said processor and configured for:
determining a type of vehicle;
responsive to determining said type of vehicle, receiving information for display; and
displaying said information.

8. The system according to claim 7, wherein said instructions are further configured for:
receiving said information for display responsive to determining a location where said vehicle is parked.

9. The system according to claim 7, wherein said instructions are further configured for:
receiving said information for display responsive to determining a date and/or time at a location where said vehicle is parked.

10. The system according to claim 7, wherein said instructions are further configured for:
receiving said information for display responsive to determining a distance between a predetermined location and a location where said vehicle is parked.

11. The system according to claim 7, wherein said instructions are further configured for:
receiving said information for display responsive to other vehicles located near said at least one vehicle, wherein said received information forms part of a collective display.

12. The system according to claim 7, wherein said instructions are further configured for:
receiving said information for display responsive to other vehicles located near said at least one vehicle, wherein said received information provides additional details to an existing display on said other vehicles.

13. A computer-usable medium embodying computer program code, said computer program code comprising computer-executable instructions configured for:
determining a type of vehicle;
responsive to determining said type of vehicle, receiving information for display; and
displaying said information.

14. The computer-usable medium according to claim 13, wherein said embodied computer program code further comprises computer-executable instructions configured for:
receiving said information for display responsive to determining a location where said vehicle is parked.

15. The computer-usable medium according to claim 13, wherein said embodied computer program code further comprises computer-executable instructions configured for:
receiving said information for display responsive to determining a date and/or time at a location where said vehicle is parked.

16. The computer-usable medium according to claim 13, wherein said embodied computer program code further comprises computer-executable instructions configured for:
receiving said information for display responsive to determining a distance between a predetermined location and a location where said vehicle is parked.

17. The computer-usable medium according to claim 13, wherein said embodied computer program code further comprises computer-executable instructions configured for:
receiving said information for display responsive to other vehicles located near said at least one vehicle, wherein said received information forms part of a collective display.

18. The computer-usable medium according to claim 13, wherein said embodied computer program code further comprises computer-executable instructions configured for:
receiving said information for display responsive to other vehicles located near said at least one vehicle, wherein said received information provides additional details to an existing display on said other vehicles.
